(19) United States
(12) Patent Application Publication
(10) Pub. No.: US 2025/0336596 A1
(43) Pub. Date: Oct. 30, 2025

(54) Coupled Inductive Device and Method for Preparing Integrally Formed Coupled Inductive Device

(71) Applicants: HUIZHOU POCO NEW INDUCTOR TECHNOLOGY CO., LTD., Huizhou (CN); HEYUAN POCO NEW MATERIAL CO., LTD., Heyuan (CN)

(72) Inventors: Tao Luo, Shenzhen (CN); Zhihang Jiang, Shenzhen (CN)

(73) Assignees: HUIZHOU POCO NEW INDUCTOR TECHNOLOGY CO., LTD., Huizhou (CN); HEYUAN POCO NEW MATERIAL CO., LTD., Heyuan (CN)

(21) Appl. No.: 19/186,920

(22) Filed: Apr. 23, 2025

(30) Foreign Application Priority Data
Apr. 24, 2024 (CN) 202410496841.X

(51) Int. Cl. H01F 27/32; H01F 27/30; H01F 41/02; H01F 41/12

(52) U.S. Cl. CPC H01F 27/324; H01F 27/306; H01F 41/0246; H01F 41/125

(57) ABSTRACT

Provided are a coupled inductive device and a method for preparing an integrally formed coupled inductive device. The coupled inductive device includes an insulative magnetic core and at least two windings, where at least two grooves are disposed in the insulative magnetic core at intervals along a first direction; and the at least two windings are located in the at least two grooves in one-to-one correspondence. The insulative magnetic core further includes at least one accommodating hole and a non-magnetic insulative layer located in the accommodating hole, where an accommodating hole extends in a second direction and is located between two adjacent grooves, two adjacent grooves disposed in the first direction are connected through an accommodating hole, and the coupling coefficient between two windings in the two adjacent grooves is related to the thickness of the non-magnetic insulative layer disposed between the two windings in a third direction.

### CROSS-REFERENCE TO RELATED APPLICATION(S)

This application claims priority to Chinese Patent Application No. 202410496841.X filed Apr. 24, 2024, the disclosure of which is incorporated herein by reference in its entirety.

### TECHNICAL FIELD

Embodiments of the present disclosure relate to the field of coupled inductors and, in particular, to a coupled inductive device and a method for preparing an integrally formed coupled inductive device.

### BACKGROUND

Coupled inductors are categorized as positively coupled inductors and negatively coupled inductors and are generally used in polyphase topology circuits to leverage current ripple cancellation generated by magnetic coupling between two phases.

At present, a coupled inductor device is generally composed of two magnetic cores, a primary winding, and a secondary winding. However, such a coupled inductor device is prone to causing short circuits during the forming process of the primary winding and the secondary winding, and the coupling coefficient between the primary winding and the secondary winding is not easily adjustable.

### SUMMARY

Embodiments of the present disclosure provide a coupled inductive device and a method for preparing an integrally formed coupled inductive device, which can avoid short circuits between windings and can adjust the coupling coefficient between two windings, thereby enhancing the energy storage capacity and anti-saturation performance.

In a first aspect, an embodiment of the present disclosure provides a coupled inductive device. The coupled inductive device includes an insulative magnetic core and at least two windings. The at least two grooves are disposed in the insulative magnetic core, and the at least two grooves are disposed at intervals in a first direction.

The at least two windings are located in the at least two grooves in one-to-one correspondence.

The insulative magnetic core further includes at least one accommodating hole and a non-magnetic insulative layer located in the at least one accommodating hole. An accommodating hole extends in a second direction and is located between two adjacent grooves, and two adjacent grooves disposed in the first direction are connected through an accommodating hole. The second direction intersects the first direction.

The coupling coefficient between two windings in the two adjacent grooves is related to the thickness of the non-magnetic insulative layer disposed between the two windings in a third direction.

The third direction is perpendicular to the second direction and the first direction.

In one or more embodiments, a high-temperature resistance range of the insulative magnetic core is greater than or equal to 600° C. and less than or equal to 850° C.; and/or a high-temperature resistance range of the non-magnetic insulative layer is greater than or equal to 600° C. and less than or equal to 850° C.

In one or more embodiments, a groove includes a first sub-groove, a second sub-groove, and a third sub-groove that communicate with one another.

The first sub-groove extends from an inside of the insulative magnetic core to a surface of the insulative magnetic core, the second sub-groove extends from the inside of the insulative magnetic core to a surface of the insulative magnetic core, and the third sub-groove is located in the insulative magnetic core and connects to the first sub-groove and the second sub-groove.

A winding includes a first connection portion, a main body portion, and a second connection portion. The first connection portion is located in the first sub-groove, the second connection portion is located in the second sub-groove, and the main body portion is located in the third sub-groove.

The first connection portion serves as a current input terminal and the second connection portion serves as a current output terminal; or the first connection portion serves as a current output terminal and the second connection portion serves as a current input terminal.

In one or more embodiments, the thickness of the non-magnetic insulative layer in the third direction is greater than or equal to 0.01 mm and less than or equal to twice the thickness of the main body portion.

In one or more embodiments, in one groove, the first sub-groove and the second sub-groove extend from the inside of the insulative magnetic core to two opposite surfaces of the insulative magnetic core, and the first connection portion and the second connection portion are located on the two opposite surfaces of the insulative magnetic core, respectively.

In one or more embodiments, in one groove, the first sub-groove and the second sub-groove extend from the inside of the insulative magnetic core to the same surface of the insulative magnetic core, and the first connection portion and the second connection portion are located on the same surface of the insulative magnetic core.

In one or more embodiments, two adjacent windings disposed in the first direction have opposite current directions.

In one or more embodiments, current input terminals of two adjacent windings are located on a first surface of the insulative magnetic core, current output terminals of the two adjacent windings are located on a second surface of the insulative magnetic core, and the first surface and the second surface are opposite each other.

In one or more embodiments, two adjacent windings disposed in the first direction have the same current direction.

In one or more embodiments, current input terminals and current output terminals of two adjacent windings are located on the same surface of the insulative magnetic core.

In one or more embodiments, the insulative magnetic core, the windings, and the non-magnetic insulative layer are an integrally formed structure, and the material of the non-magnetic insulative layer is at least one of mica, ceramic or aluminum oxide.

In a second aspect, an embodiment of the present disclosure further provides a method for preparing an integrally formed coupled inductive device. The method includes the following steps.

An insulative magnetic core powder is provided, where the insulative magnetic core powder includes a first portion insulative magnetic core powder and a second portion insulative magnetic core powder that are separated from each other.

At least two windings are placed on the first portion insulative magnetic core powder, where the at least two windings are disposed at intervals in a first direction, a non-magnetic insulative layer is placed between two adjacent windings, the non-magnetic insulative layer extends in a second direction, two adjacent windings disposed in the first direction are connected through the non-magnetic insulative layer, and the second direction intersects the first direction.

The second portion insulative core powder overlies the at least two windings and the non-magnetic insulative layer, where the at least two windings and the non-magnetic insulative layer are completely overlaid with the second portion insulative magnetic core powder and the first portion insulative magnetic core powder.

The first portion insulative magnetic core powder, the at least two windings, the non-magnetic insulative layer, and the second portion insulative magnetic core powder are formed into an integrally formed structure by a pressing process.

In the technical solutions provided in the embodiments of the present disclosure, at least two grooves are disposed in the insulative magnetic core, the at least two grooves are disposed at intervals in the first direction, and the at least two windings are located in the at least two grooves in one-to-one correspondence; the insulative magnetic core further includes at least one accommodating hole and a non-magnetic insulative layer located in the at least one accommodating hole; the accommodating hole extends in the second direction and is located between two adjacent grooves, two adjacent grooves disposed in the first direction are connected through an accommodating hole, and the second direction intersects the first direction. The coupling coefficient between two windings in the two adjacent grooves is related to the thickness of the non-magnetic insulative layer disposed between the two windings in the third direction. In the embodiments of the present disclosure, short circuits between two adjacent windings can be avoided through the insulative magnetic core and the non-magnetic insulative layer between the two adjacent windings. Since the coupling coefficient between the two windings is related to the thickness of the non-magnetic insulative layer located between the two windings in the third direction, the coupling coefficient between the two windings can be increased and adjusted by changing the thickness of the non-magnetic insulative layer. Moreover, by setting the non-magnetic insulative layer between two adjacent windings, the mutual inductance of the two windings is increased, thereby enhancing energy storage capacity and anti-saturation performance.

It is to be understood that the content described in this part is neither intended to identify key or important features of embodiments of the present disclosure nor intended to limit the scope of the present disclosure. Other features of the present disclosure are readily understood from the description provided hereinafter.

### BRIEF DESCRIPTION OF DRAWINGS

To illustrate solutions in embodiments of the present disclosure more clearly, the drawings to be used in the description of the embodiments are described below briefly. Apparently, the drawings described below illustrate part of the embodiments of the present disclosure, and those of ordinary skill in the art may obtain other drawings based on these drawings on the premise that no creative work is done.

FIG. 1 is a structure view of a coupled inductive device according to an embodiment of the present disclosure;

FIG. 2 is a cross-sectional view of a winding in FIG. 1 taken along A1-A2 direction;

FIG. 3 is a graph showing the relationship between the thickness of the non-magnetic insulative layer and the coupling coefficient according to an embodiment of the present disclosure;

FIG. 4 is a cross-sectional view of the coupled inductive device in FIG. 1 taken along B1-B2 direction;

FIG. 5 is a structure view of another coupled inductive device according to an embodiment of the present disclosure;

FIG. 6 is a cross-sectional view of the coupled inductive device in FIG. 5 taken along C1-C2 direction;

FIG. 7 is a cross-sectional view of a winding in FIG. 5 taken along D1-D2 direction; and

FIG. 8 is a flowchart of a method for preparing an integrally formed coupled inductive device according to an embodiment of the present disclosure.

### DETAILED DESCRIPTION

For a better understanding of the solutions of the present disclosure by those skilled in the art, the solutions in embodiments of the present disclosure are described below clearly and completely in conjunction with the drawings in the embodiments of the present disclosure. Apparently, the embodiments described below are part, not all, of the embodiments of the present disclosure. Based on the embodiments described herein, all other embodiments obtained by those of ordinary skill in the art on the premise that no creative work is done are within the scope of the present disclosure.

It is to be noted that the terms “first”, “second”, and the like in the description, claims, and drawings of the present disclosure are used for distinguishing between similar objects and are not necessarily used for describing a particular order or sequence. It is to be understood that data used in this manner are interchangeable where appropriate so that the embodiments of the present disclosure described herein can be implemented in an order not illustrated or described herein. In addition, the terms “including”, “having”, and any variations thereof are intended to encompass a non-exclusive inclusion. For example, a process, method, system, product, or device that includes a series of steps or units not only includes the expressly listed steps or units but may also include other steps or units that are not expressly listed or are inherent to such a process, method, product, or device.

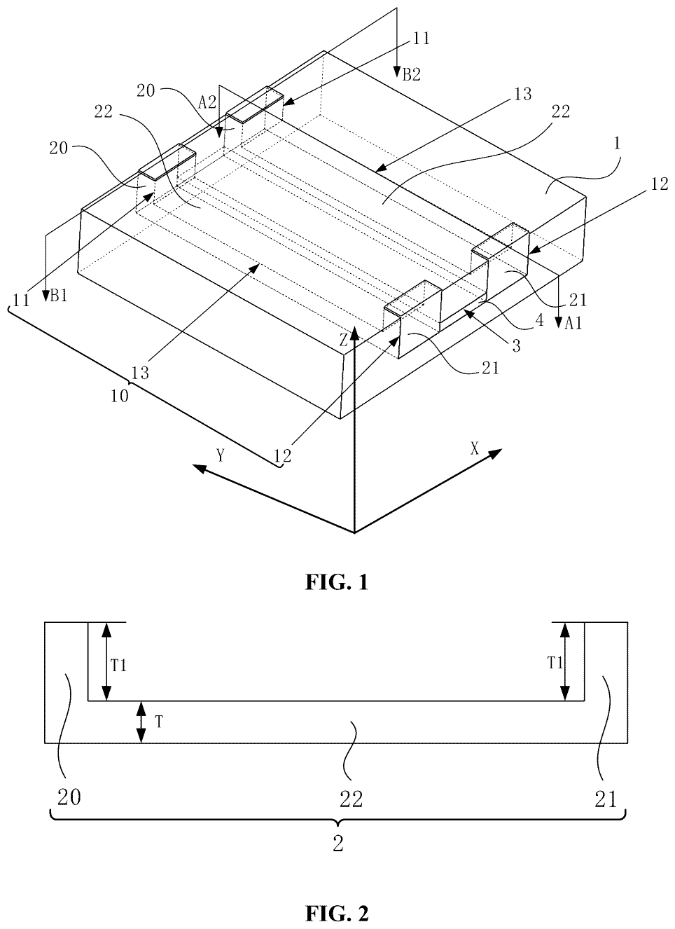

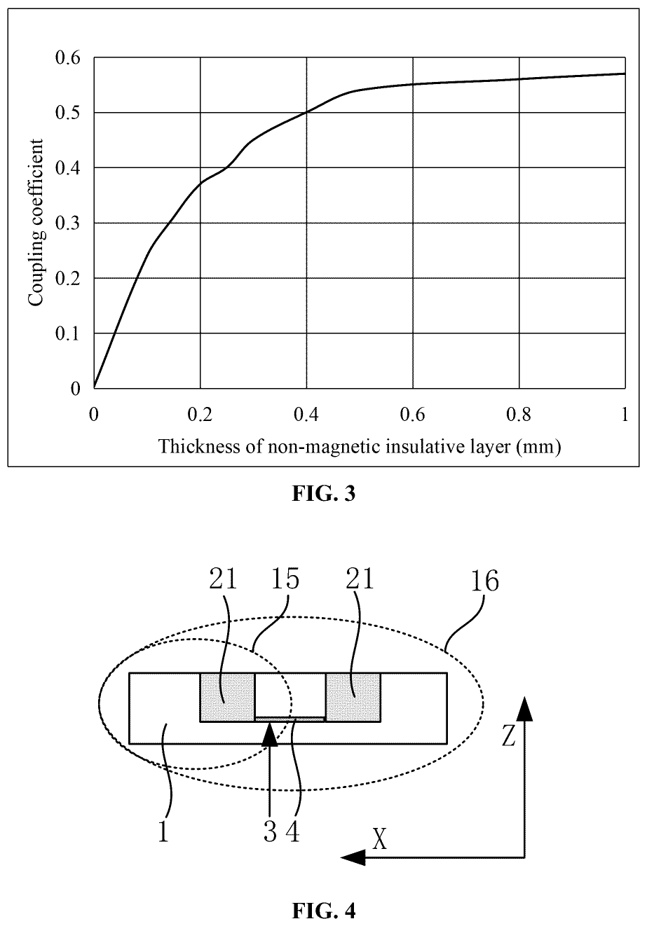

FIG. 1 is a structure view of a coupled inductive device according to an embodiment of the present disclosure. FIG. 2 is a cross-sectional view of a winding in FIG. 1 taken along A1-A2 direction. FIG. 3 is a graph showing the relationship between the thickness of the non-magnetic insulative layer and the coupling coefficient according to an embodiment of the present disclosure. FIG. 4 is a cross-sectional view of the coupled inductive device in FIG. 1 taken along B1-B2 direction. Referring to FIGS. 1 and 2, the coupled inductive device includes an insulative magnetic core 1 and at least two windings 2. At least two grooves 10 are disposed in the insulative magnetic core 1 and arranged at intervals in a first direction X. The at least two windings 2 are located in the at least two grooves 10 in one-to-one correspondence. The insulative magnetic core 1 further includes at least one accommodating hole 3 and a non-magnetic insulative layer 4. An accommodating hole 3 extends in a second direction Y and is located between two adjacent grooves 10, and two adjacent grooves 10 disposed in the first direction X are connected through an accommodating hole 3. The second direction Y intersects the first direction X, and a third direction Z is perpendicular to the second direction Y and the first direction X. The coupling coefficient between two windings 2 in the two adjacent grooves 10 is related to the thickness of the non-magnetic insulative layer 4 disposed between the two windings 2 in the third direction Z.

Referring to FIG. 1, a groove 10 includes a first sub-groove 11, a second sub-groove 12, and a third sub-groove 13 that communicate with one another. In FIG. 1, X represents the first direction, Y represents the second direction, and Z represents the third direction. Referring to FIG. 4, the interval of two grooves 10 in the first direction X is equal to the width of the accommodating hole 3, and the depth of the groove 10 is smaller than the depth of the insulative magnetic core 1. Referring to FIG. 2, a winding 2 includes a first connection portion 20, a second connection portion 21, and a main body portion 22. The winding 2 may be a coil or a conductive sheet, and the material used for the winding 2 is preferably copper. The thickness of the winding 2 is 0.5 mm, and no insulative material is coated on the surface of the winding 2.

When at least two windings 2 are energized or de-energized, a magnetic field is generated around each winding 2. The magnetic field generated by each winding 2 is coupled with the magnetic field generated by an adjacent winding 2, and each winding 2 generates an induced current under the magnetic field generated by the adjacent winding 2. Since the insulative magnetic core 1 and the non-magnetic insulative layer 4 between each winding 2 have the characteristics of high-temperature resistance and good insulation, the short circuits between two adjacent windings 2 can be avoided.

When the interval between the at least two windings 2 in the first direction X is too small, the coupling coefficient between two adjacent windings 2 is high, and there is no need to adjust the coupling coefficient between the two adjacent windings 2 by changing the thickness of the non-magnetic insulative layer 4. When the interval between the at least two windings 2 in the first direction X is large, the magnetic fields generated by the two windings 2 propagate along a first path 15, and the magnetic resistance of the non-magnetic insulative layer 4 is increased by gradually increasing the thickness of the non-magnetic insulative layer 4 so that the magnetic fields are prevented from passing between the two adjacent windings 2, that is, the magnetic fields generated by the windings 2 propagate along a second path 16, thereby increasing the coupling between two adjacent windings 2.

For example, referring to FIG. 3, when the thickness of the non-magnetic insulative layer 4 is increased from 0.01 mm to 1.0 mm, the coupling coefficient is increased from 0.003 to 0.57. As the thickness of the non-magnetic insulative layer 4 is increased, the coupling coefficient is gradually increased, and thus, the coupling coefficient between two adjacent windings 2 can be increased by increasing the thickness of the non-magnetic insulative layer 4.

TABLE 1
Relationship between the thickness of the non-magnetic
insulative layer and the coupling coefficient

| Thickness of non-magnetic insulative layer | Coupling coefficient |
|---|---|
| 0.1 mm | 0.24 |
| 0.25 mm | 0.4 |
| 0.5 mm | 0.54 |
| 0.8 mm | 0.56 |
| 1.0 mm | 0.57 |

The coupling coefficient is 0.24 when the thickness of the non-magnetic insulative layer 4 is 0.1 mm; the coupling coefficient is 0.4 when the thickness of the non-magnetic insulative layer 4 is 0.25 mm; the coupling coefficient is 0.54 when the thickness of the non-magnetic insulative layer 4 is 0.5 mm; the coupling coefficient is 0.56 when the thickness of the non-magnetic insulative layer 4 is 0.8 mm; and the coupling coefficient is 0.57 when the thickness of the non-magnetic insulative layer 4 is 1.0 mm.

In the technical solutions provided in the embodiments of the present disclosure, at least two grooves 10 are disposed in the insulative magnetic core 1, the at least two grooves 10 are disposed at intervals in the first direction X, and at least two windings 2 are located in the at least two grooves 10 in one-to-one correspondence; the insulative magnetic core 1 further includes at least one accommodating hole 3 and a non-magnetic insulative layer 4; the accommodating hole 3 extends in the second direction Y and is located between two adjacent grooves 10, and two adjacent grooves 10 disposed in the first direction X are connected through an accommodating hole 3; the non-magnetic insulative layer 4 is located in the at least one accommodating hole 3; the coupling coefficient between two windings 2 in the two adjacent grooves 10 is related to the thickness of the non-magnetic insulative layer 4 disposed between the two windings 2 in the third direction Z. In the embodiments of the present disclosure, short circuits between two adjacent windings 2 can be avoided through the insulative magnetic core 1 and the non-magnetic insulative layer 4 between the two adjacent windings 2. Since the coupling coefficient between the two windings 2 is related to the thickness of the non-magnetic insulative layer 4 located between the two windings 2 in the third direction Z, the coupling coefficient between the two windings 2 can be increased by changing the thickness of the non-magnetic insulative layer 4 to increase induced electric charge between the two windings 2, thereby enhancing the energy storage capacity and anti-saturation performance.

Referring to FIG. 1, on the basis of the preceding embodiments, a high-temperature resistance range of the insulative magnetic core is greater than or equal to 600° C. and less than or equal to 850° C.; and/or a high-temperature resistance range of the non-magnetic insulative layer is greater than or equal to 600° C. and less than or equal to 850° C.

The range of 600° C.-850° C. is used for high-temperature annealing during preparation of the coupled inductor device. High-temperature annealing is a process for preparing the coupled inductive device. The magnetic material used in the insulative magnetic core 1 includes, but is not limited to, an iron-silicon-aluminum material and an iron-nickel material, and such a magnetic material is a material having high-temperature resistance, strong magnetic properties, and good insulating properties. The material used in the non-magnetic insulative layer 4 includes, but is not limited to, mica, ceramic, and aluminum oxide, and such a non-magnetic material has high-temperature resistance, weak magnetic properties, and good insulating properties.

When the coupled inductive device is prepared at 600° C.-850° C., it is necessary to ensure that the materials used in the insulative magnetic core 1 and the non-magnetic insulative layer 4 are prevented from being damaged at the temperature of 600° C.-850° C. Therefore, the insulative magnetic core 1 and the non-magnetic insulative layer 4 still have good insulating properties at the temperature of 600° C.-850° C. to avoid short circuits between two windings 2.

Still referring to FIGS. 1 and 2, on the basis of the preceding embodiments, a groove 10 includes a first sub-groove 11, a second sub-groove 12, and a third sub-groove 13 that communicate with one another. The first sub-groove 11 extends from the inside of the insulative magnetic core 1 to the surface of the insulative magnetic core 1, the second sub-groove 12 extends from the inside of the insulative magnetic core 1 to the surface of the insulative magnetic core 1, and the third sub-groove 13 is located in the insulative magnetic core 1 and connects to the first sub-groove 11 and the second sub-groove 12. A winding 2 includes a first connection portion 20, a main body portion 22, and a second connection portion 21. The first connection portion 20 is located in the first sub-groove 11, the second connection portion 21 is located in the second sub-groove 12, and the main body portion 22 is located in the third sub-groove 13. The first connection portion 20 serves as a current input terminal and the second connection portion 21 serves as a current output terminal; or the first connection portion 20 serves as a current output terminal and the second connection portion 21 serves as a current input terminal.

The thickness T1 of the first connection portion 20 and the thickness T1 of the second connection portion 21 are the same, and the thickness of the main body portion 22 is T. Referring to FIG. 1, when the current is input from the first connection portions 20 of the two windings 2 and output from the second connection portions 21 thereof, the current flows through the first connection portions 20 and reach the main body portions 22 so that the current flowing through the main body portions 22 of the two windings 2 flows in the same current direction.

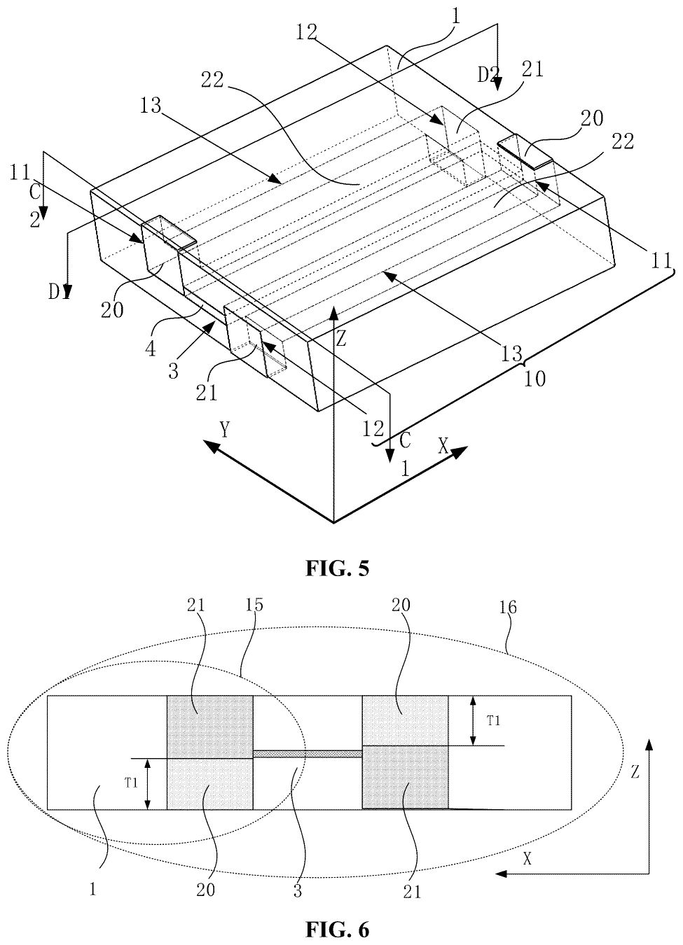

FIG. 5 is a structure view of another coupled inductive device according to an embodiment of the present disclosure. Referring to FIG. 5, when the current is input from the second connection portions 21 and output from the first connection portions 20, the current flowing through the main body portions 22 of the two windings 2 has different current directions.

In the embodiments of the present disclosure, by setting the first connection portion 20 in the first sub-groove 11, the second connection portion 21 in the second sub-groove 12, and the main body portion 22 in the third sub-groove 13, the winding 2 is tightly bound to the insulative magnetic core 1 to form a shielding structure, and such a structure has strong vibration resistance, can avoid noise, and has a strong anti-electromagnetic interference ability. In addition, by using the first connection portion 20 as the current input terminal and the second connection portion 21 as the current output terminal or using the first connection portion 20 as the current output terminal and the second connection portion 21 as the current input terminal, power supply to external devices is achieved.

Referring to FIGS. 1 and 2, on the basis of the preceding embodiments, the thickness of the non-magnetic insulative layer 4 in the third direction Z is greater than or equal to 0.01 mm and less than or equal to twice the thickness T of the main body portion 22.

Referring to FIG. 2, the thickness T of the main body portion 22 is the thickness of the winding 2.

In the embodiments of the present disclosure, as the thickness of the non-magnetic insulative layer 4 is increased, the coupling coefficient between two windings 2 is increased.

FIG. 6 is a cross-sectional view of the coupled inductive device in FIG. 5 taken along C1-C2 direction. Referring to FIGS. 5 and 6, in one groove 10, the first sub-groove 11 and the second sub-groove 12 extend from the inside of the insulative magnetic core 1 to two opposite surfaces of the insulative magnetic core 1, and the first connection portion 20 and the second connection portion 21 are located on the two opposite surfaces of the insulative magnetic core 1, respectively.

The sum of the thickness T1 of the first connection portion 20, the thickness T1 of the second connection portion 21, and the thickness T of the main body portion 22 is equal to the thickness of the insulative magnetic core 1.

In the embodiments of the present disclosure, by setting the first connection portion 20 and the second connection portion 21 on the two opposite surfaces respectively, power supply to external devices located on the two opposite surfaces of the insulative magnetic core 1 can be achieved.

Still referring to FIG. 1, on the basis of the preceding embodiments, in one groove, the first sub-groove 11 and the second sub-groove 12 extend from the inside of the insulative magnetic core 1 to the same surface of the insulative magnetic core 1, and the first connection portion 20 and the second connection portion 21 are located on the same surface of the insulative magnetic core 1.

In the embodiments of the present disclosure, by setting the first connection portion 20 and the second connection portion 21 on the same surface of the insulative magnetic core 1, power supply to external devices located on the same surface of the insulative magnetic core 1 can be achieved.

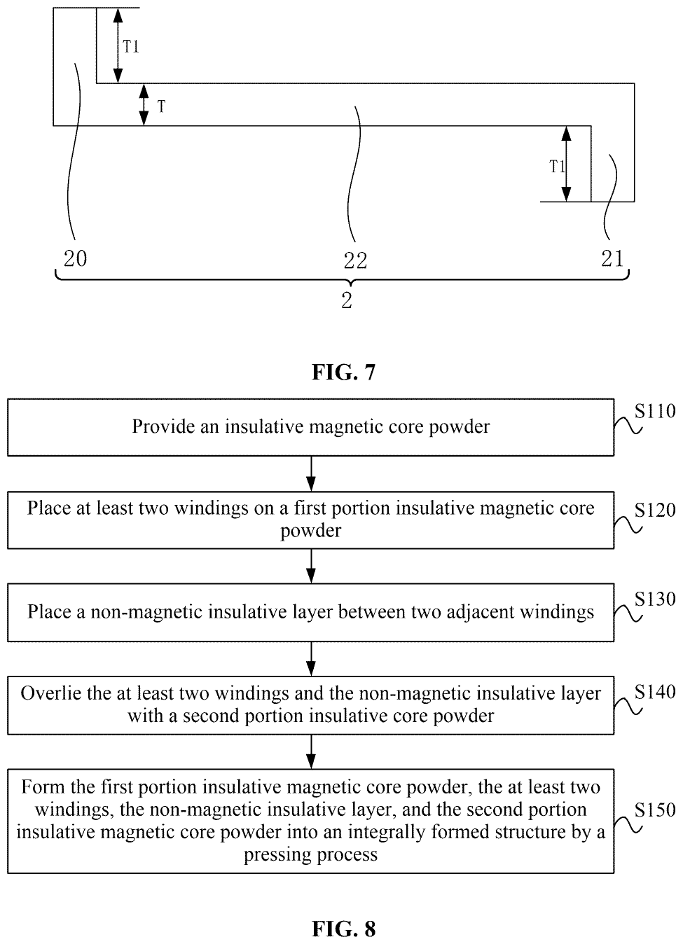

FIG. 7 is a cross-sectional view of a winding in FIG. 5 taken along D1-D2 direction. Referring to FIG. 7, on the basis of the preceding embodiments, two adjacent windings 2 disposed in the first direction have opposite current directions.

Referring to FIG. 7, the thickness T of the main body portion 22 is the thickness of the winding 2. The first connection portion 20 serves as the current input terminal, the second connection portion 21 serves as the current output terminal, and then two adjacent windings 2 disposed in the first direction X have opposite current directions. Through the preceding setting, power supply to external devices in the vertical direction is achieved.

Still referring to FIG. 5, on the basis of the preceding embodiments, current input terminals of two adjacent windings 2 are located on a first surface of the insulative magnetic core 1, current output terminals of the two adjacent windings 2 are located on a second surface of the insulative magnetic core 1, and the first surface and the second surface are opposite each other.

In the embodiments of the present disclosure, by setting the current input terminals of two adjacent windings 2 on the first surface of the insulative magnetic core 1 and the current output terminals of the two adjacent windings 2 on the second surface of the insulative magnetic core 1, power supply to external devices located on the second surface of the insulative magnetic core 1 is achieved.

Still referring to FIG. 1, on the basis of the preceding embodiments, two adjacent windings 2 disposed in the first direction X have the same current direction.

The first connection portion 20 serves as the current input terminal, the second connection portion 21 serves as the current output terminal, and then two adjacent windings 2 disposed in the first direction X have the same current direction.

Still referring to FIG. 1, on the basis of the preceding embodiments, current input terminals and current output terminals of two adjacent windings 2 are located on the same surface of the insulative magnetic core 1.

In the embodiments of the present disclosure, by setting the current input terminals and the current output terminals of two adjacent windings 2 on the same surface of the insulative magnetic core, power supply to external devices located on the same surface of the insulative magnetic core can be achieved.

Still referring to FIG. 1, on the basis of the preceding embodiments, the insulative magnetic core 1, the windings 2, and the non-magnetic insulative layer 4 are an integrally formed structure, and the material of the non-magnetic insulative layer 4 is at least one of mica, ceramic, and aluminum oxide. That is, the coupled inductive device is integrally formed by collectively placing insulative magnetic powders for constituting the insulative magnetic core 1, the windings 2, and the non-magnetic insulative layer 4 into a mold cavity and press-bonding them.

It is to be understood that in other embodiments, the insulative magnetic core 1 may include a pre-pressed first insulative magnetic core and second insulative magnetic core. The groove 10 and the accommodating hole 3 are pre-formed on the pre-pressed first insulative magnetic core and/or second insulative magnetic core, the winding 2 and the non-magnetic insulative layer 4 are disposed in the groove 10 and the accommodating hole 3, respectively, and then the first insulative magnetic core and the second insulative magnetic core are combined to form a coupled inductive device.

FIG. 8 is a flowchart of a method for preparing an integrally formed coupled inductive device according to an embodiment of the present disclosure. Referring to FIG. 8, the method includes steps S110 to S150.

In S110, an insulative magnetic core powder is provided, where the insulative magnetic core powder includes a first portion insulative magnetic core powder and a second portion insulative magnetic core powder that are separated from each other.

In S120, at least two windings are placed on the first portion insulative magnetic core powder, where the at least two windings are disposed at intervals in the first direction.

In S130, a non-magnetic insulative layer is placed between two adjacent windings, where the non-magnetic insulative layer extends in a second direction, two adjacent windings disposed in the first direction are connected through the non-magnetic insulative layer, and the second direction intersects the first direction.

In S140, the second portion insulative core powder overlies the at least two windings and the non-magnetic insulative layer, where the second portion insulative magnetic core powder and the first portion insulative magnetic core powder completely overlie the at least two windings and the non-magnetic insulative layer.

In S150, the first portion insulative magnetic core powder, the at least two windings, the non-magnetic insulative layer, and the second portion insulative magnetic core powder are formed into an integrally formed structure by a pressing process.

After the at least two windings, the first portion insulative magnetic core powder, and the second portion insulative magnetic core powder are pressed, at least two grooves are formed inside the pressed structure, and the windings are located in the grooves in one-to-one correspondence. After the first portion insulative magnetic core powder and the second portion insulative magnetic core powder are pressed, at least one accommodating hole is further formed inside the pressed structure, the accommodating hole extends in the second direction and is located between two adjacent grooves, two adjacent grooves disposed in the first direction are connected through an accommodating hole, and the non-magnetic insulative layer is located in the accommodating hole.

It is to be understood that various forms of the preceding flows may be used with steps reordered, added, or removed. For example, the steps described in the present disclosure may be executed in parallel, in sequence, or in a different order as long as the desired results of the solutions of the present disclosure can be achieved. The execution sequence of these steps is not limited herein.

The preceding embodiments are not intended to limit the scope of the present disclosure. It is to be understood by those skilled in the art that various modifications, combinations, subcombinations, and substitutions may be made according to design requirements and other factors. Any modification, equivalent substitution or improvement made within the spirit and principle of the present disclosure falls within the scope of the present disclosure.

What is claimed is:

1. A coupled inductive device, comprising:
an insulative magnetic core, wherein at least two grooves are disposed in the insulative magnetic core, and the at least two grooves are disposed at intervals in a first direction; and
at least two windings, wherein the at least two windings are located in the at least two grooves in one-to-one correspondence;
wherein the insulative magnetic core further comprises at least one accommodating hole and a non-magnetic insulative layer located in the at least one accommodating hole, wherein an accommodating hole of the at least one accommodating hole extends in a second direction and is located between two adjacent grooves of the at least two grooves, the two adjacent grooves disposed in the first direction are connected through the accommodating hole, and the second direction intersects the first direction;
wherein a coupling coefficient between two windings in the two adjacent grooves is related to a thickness of the non-magnetic insulative layer disposed between the two windings in a third direction; wherein the third direction is perpendicular to the second direction and the first direction.

2. The coupled inductive device according to claim 1, wherein
a high-temperature resistance range of at least one of the insulative magnetic core or the non-magnetic insulative layer is greater than or equal to 600° C. and less than or equal to 850° C.

3. The coupled inductive device according to claim 1, wherein a groove of the at least two grooves comprises a first sub-groove, a second sub-groove, and a third sub-groove that communicate with one another;
the first sub-groove extends from an inside of the insulative magnetic core to a surface of the insulative magnetic core, the second sub-groove extends from the inside of the insulative magnetic core to a surface of the insulative magnetic core, and the third sub-groove is located in the insulative magnetic core and connects to the first sub-groove and the second sub-groove;
a winding of the at least two windings comprises a first connection portion, a main body portion, and a second connection portion, the first connection portion is located in the first sub-groove, the second connection portion is located in the second sub-groove, and the main body portion is located in the third sub-groove; and
the first connection portion serves as a current input terminal and the second connection portion serves as a current output terminal; or the first connection portion serves as a current output terminal and the second connection portion serves as a current input terminal.

4. The coupled inductive device according to claim 3, wherein the thickness of the non-magnetic insulative layer in the third direction is greater than or equal to 0.01 mm and less than or equal to twice a thickness of the main body portion.

5. The coupled inductive device according to claim 3, wherein in one of the at least two grooves, the first sub-groove and the second sub-groove extend from the inside of the insulative magnetic core to two opposite surfaces of the insulative magnetic core; and
the first connection portion and the second connection portion are located on the two opposite surfaces of the insulative magnetic core, respectively.

6. The coupled inductive device according to claim 3, wherein in one of the at least two grooves, the first sub-groove and the second sub-groove extend from the inside of the insulative magnetic core to a same surface of the insulative magnetic core; and
the first connection portion and the second connection portion are located on the same surface of the insulative magnetic core.

7. The coupled inductive device according to claim 5, wherein two adjacent windings of the at least two windings disposed in the first direction have opposite current directions.

8. The coupled inductive device according to claim 7, wherein current input terminals of the two adjacent windings are located on a first surface of the insulative magnetic core, current output terminals of the two adjacent windings are located on a second surface of the insulative magnetic core, and the first surface and the second surface are opposite each other.

9. The coupled inductive device according to claim 6, wherein two adjacent windings of the at least two windings disposed in the first direction have a same current direction.

10. The coupled inductive device according to claim 9, wherein current input terminals and current output terminals of the two adjacent windings are located on the same surface of the insulative magnetic core.

11. The coupled inductive device according to claim 1, wherein the insulative magnetic core, the at least two windings, and the non-magnetic insulative layer are an integrally formed structure, and a material of the non-magnetic insulative layer is at least one of mica, ceramic or aluminum oxide.

12. A method for preparing an integrally formed coupled inductive device, comprising:
providing an insulative magnetic core powder, wherein the insulative magnetic core powder comprises a first portion insulative magnetic core powder and a second portion insulative magnetic core powder that are separated from each other;
placing at least two windings on the first portion insulative magnetic core powder, wherein the at least two windings are disposed at intervals in a first direction;
placing a non-magnetic insulative layer between two adjacent windings of the at least two windings, wherein the non-magnetic insulative layer extends in a second direction, the two adjacent windings disposed in the first direction are connected through the non-magnetic insulative layer, and the second direction intersects the first direction;
overlying the at least two windings and the non-magnetic insulative layer with the second portion insulative core powder over, wherein the at least two windings and the non-magnetic insulative layer are completely overlaid with the second portion insulative magnetic core powder and the first portion insulative magnetic core powder; and
forming the first portion insulative magnetic core powder, the at least two windings, the non-magnetic insulative layer, and the second portion insulative magnetic core powder into an integrally formed structure by a pressing process.
